(19) United States
(12) Patent Application Publication
(10) Pub. No.: US 2013/0176108 A1
(43) Pub. Date: Jul. 11, 2013

(54) AUTOMATED MECHANISM TO SWITCH USER DATA SETS IN A TOUCH-BASED DEVICE

(71) Applicants: Sunil Madhani, Mumbai (IN); Anu Sreepathy, Bangalore (IN); Samir Kakkar, Bangalore (IN)

(72) Inventors: Sunil Madhani, Mumbai (IN); Anu Sreepathy, Bangalore (IN); Samir Kakkar, Bangalore (IN)

(73) Assignee: INTUIT INC., Mountain View, CA (US)

(21) Appl. No.: 13/345,459

(22) Filed: Jan. 6, 2012

(51) Int. Cl. G06F 7/04

(52) U.S. Cl. 340/5.82

(57) ABSTRACT

A method to use a single touch-based device for a set of users involves analyzing a biometric signal of a user, obtained using a biometric sensor of the single touch-based device, to generate a biometric data item; determining an identity of the user by comparing the biometric data item to a set of biometric data items stored in the single touch-based device; activating, in response solely to the biometric signal and based on the identity of the user, a user data set residing on the single touch-based device, where the user data set belongs to the user; and performing, in response to a touch input from the user and activation of the user data set, a task on the single touch-based device using the user data set.

### BACKGROUND

A touchscreen capable of receiving touch input is an electronic visual display that can detect the presence and location of a touch within the display area. The term “touch” generally refers to touching the display of a computing device with a finger or a stylus to input data into the computing device. Such computing device with a touchscreen is referred to as a touch-based device. Mobile computing devices (e.g., smartphone, personal digital assistant or PDA, global positioning service device or GPS, gaming device, tablet computer, etc.) are often touch-based devices with or without a miniature physical keyboard.

Enabling sharing of a single computing device can be cost effective for a company or a household. Multiple users can share the same computing device or the same application in the computing device (e.g., email application) using different user data sets. Generally, switching user data sets involves a task of keying-in identity credentials, which can be cumbersome on a touch-based device due to the miniature keyboard or lack of a physical keyboard on such devices.

### SUMMARY

In general, in one aspect, the invention relates to a method to use a single touch-based device for a set of users. The method includes: analyzing a biometric signal of a user, obtained using a biometric sensor of the single touch-based device, to generate a biometric data item; determining an identity of the user by comparing the biometric data item to a set of biometric data items stored in the single touch-based device; activating, in response solely to the biometric signal and based on the identity of the user, a user data set residing on the single touch-based device, wherein the user data set belongs to the user; and performing, in response to a touch input from the user and activation of the user data set, a task on the single touch-based device using the user data set.

In general, in one aspect, the invention relates to a single touch-based device for a set of users. The device includes: a processor; a touchscreen configured to receive a touch input from a user; a biometric sensor configured to obtain a biometric signal of the user; a biometric analyzer executing on the processor and configured to generate a biometric data item by analyzing the biometric signal; a user analyzer executing on the processor and configured to determine an identity of the user by comparing the biometric data item to a set of biometric data items; a user data set selector executing on the processor and configured to activate, in response solely to the biometric signal and based on the identity, a user data set residing on the single touch-based device and belonging to the user; a software application executing on the processor and configured to perform, in response to the touch input and activation of the user data set, a task on the single touch-based device using the user data set; and a repository configured to store the set of biometric data items and user data sets including the user data set.

In general, in one aspect, the invention relates to a non-transitory computer readable medium storing instructions to control a single touch-based device for a set of users. The instructions when executed by a computer processor include functionality to: analyze a biometric signal of a user, obtained using a biometric sensor of the single touch-based device, to generate a biometric data item; determine an identity of the user by comparing the biometric data item to a set of biometric data items stored in the single touch-based device; activate, in response solely to the biometric signal and based on the identity of the user, a user data set residing on the single touch-based device, wherein the user data set belongs to the user; and perform, in response to a touch input from the user and activation of the user data set, a task on the single touch-based device using the user data set.

Other aspects of the invention will be apparent from the following detailed description and the appended claims.

### BRIEF DESCRIPTION OF DRAWINGS

FIG. 1 shows a schematic diagram of a system of automated user data set switching for a touch-based device in accordance with one or more embodiments of the invention.

FIG. 2 shows a flowchart of a method of automated user data set switching for a touch-based device in accordance in accordance with one or more embodiments of the invention.

FIGS. 3A-3C show an example of automated user data set switching for a touch-based device in accordance with one or more embodiments of the invention.

FIGS. 4A-4C show an example of automated user data set switching for a touch-based device in accordance with one or more embodiments of the invention.

FIG. 5 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the invention provide a touch-based device shared by multiple users. Throughout this disclosure, the touch-based device may also be referred to as a single touch-based device to emphasize the sharing aspect. At any point in time, only one of the users has sole possession of this single touch-based device for his/her exclusive use. From time to time, the possession of this single touch-based device may be transferred from a first user to a second user marking the end of the usage period for the first user and the beginning of the usage period for the second user. In one or more embodiments, this single touch-based device is personalized for the first user during the first user usage period and personalized for the second user during the second user usage period. In particular, as described below, the personalization of this single touch-based device is automated based on biometric information of the respective user when the possession of this single touch-based device is transferred from the first user to the second user.

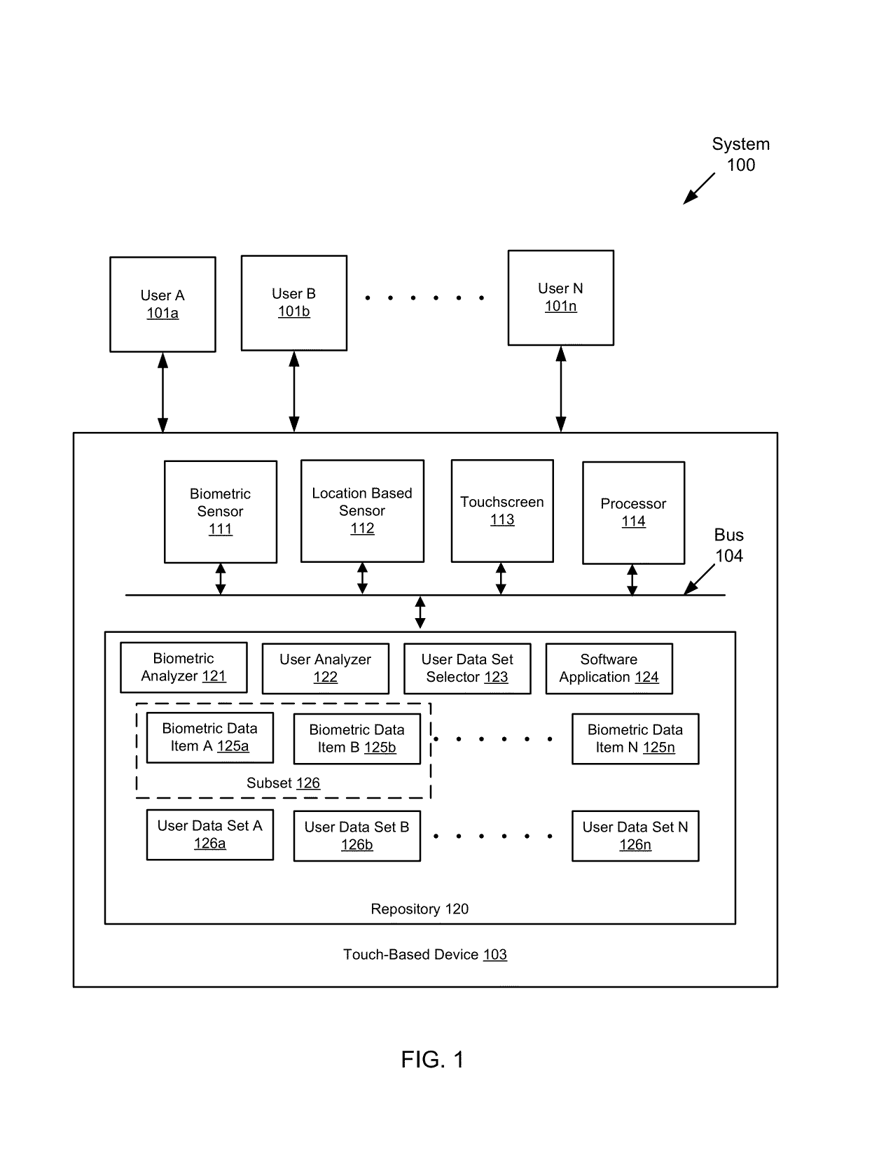

FIG. 1 depicts a schematic block diagram of a system (100) in accordance with one or more embodiments of the invention. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1. The system (100) of FIG. 1 depicts the components of a system of automated user data set switching for a touch-based device in accordance with embodiments disclosed herein.

As shown in FIG. 1, the system (100) includes users (e.g., user A (101a), user B (101b), user N (101n), etc.) sharing a touch-based device (103). For example, the touch-based device (103) may be a smartphone, a tablet computer, or other types of computing device. As shown, the touch-based device (103) includes processor (114), touchscreen (113), location-based sensor (112), biometric sensor (111), and repository (120). These various elements are coupled via a bus (104) in the touch-based device (103). The bus (104) may be a microprocessor based system bus known to those skilled in the art. In one or more embodiments, the processor (114) is configured to execute a biometric analyzer (121), user analyzer (122), user data set selector (123), and software application (124) that is stored in the repository (120). In one or more embodiments, the software application (124) may be installed onto the touch-based device (103) by one or more of the users (e.g., user A (101a), user B (101b), user N (101n)) sharing the touch-based device (103) or installed by a system administrator (not shown). In one or more embodiments, the software application (124) may be built-in to the touch-based device (103). In one or more embodiments, the biometric analyzer (121), user analyzer (122), and user data set selector (123) may be integrated into the touch-based device (103) as system software. For example, the biometric analyzer (121), user analyzer (122), and user data set selector (123) may be installed and configured onto the touch-based device (103) by a system administrator (not shown) for sharing the touch-based device (103) among the users (e.g., user A (101a), user B (101b), user N (101n), etc.). In some instances, the administrator may be one or more of the users of the touch-based device (103). The repository (120) may be a memory, any other suitable medium for storing data, or any suitable combination thereof.

The repository (120) may be used for storing biometric data item A (125a), biometric data item B (125b), biometric data item N (125n), etc. (referred to as stored biometric data items) of the user A (101a), user B (101b), user N (101n), etc., respectively. In particular, the biometric data item A (125a), biometric data item B (125b), and biometric data item N (125n) represent biometric characteristics of the user A (101a), user B (101b), and user N (101n), respectively. Such biometric characteristics may include of one or more of a facial image, a finger print, a voice segment, or other types of biometric feature. In one or more embodiments, the biometric data item of each user may contain the same types of biometric characteristic feature. In one or more embodiments, the biometric data item may be user specific and contain different types of feature for different users. For example, the biometric data item A (125a) may be related to a facial image of the user A (101a) while the biometric data item B (125b) may be related to a finger print of the user B (101b). In one or more embodiments, the biometric data item contains a composite of multiple types of biometric information relating to two or more of a facial image, a finger print, a voice segment, or other types of biometric signal of the user. In one or more embodiments, any of the stored biometric data items may include processed information in a pre-determined format (referred to as a biometric feature or a biometric signature) and/or intermediate information from which the biometric feature can be derived. For example, the biometric data item A (125a) may include a raw bitmap facial image of the user A (101a) while the biometric data item B (125b) may be related to an extracted finger print signature of the user B (101b).

The repository (120) is also configured to store user data set A (126a), user data set B (126b), user data set N (126n), etc. of the user A (101a), user B (101b), user N (101n), etc., respectively. Throughout this disclosure, the term “user data set” refers to information stored in the touch-based device (103) that is specific to a user and is typically different among different users of the touch-based device (103). For example, the user data set of a user may include (i) user description that describes who the user (e.g., identity) is and other user characteristics, as well as (ii) corresponding user specific data. For example, the user data set may include identity credentials such as user name and password, or user preference settings that customize the behavior of the touch-based device (103) or the behavior of the software application (124) running on the touch-based device (103). In one or more embodiments of the invention, the user preference settings controlling the touch-based device (103) are automatically changed when a new user login to the touch-based device (103) using his/her identity credentials.

In one or more embodiments, the touch-based device (103) includes the touchscreen (113) that is configured to (i) receive a touch input from a user as a main form of user interface input to the touch-based device (103) and (ii) display output information to the user as a main form of user interface output from the touch-based device (103). In particular, such user interface input and output may be for the software application (124) or for other native system function(s). In one or more embodiments, the touchscreen (113) may be supplemented by additional user interface input/output means, such as a microphone and a speaker. Any physical keyboard, if present, is used as an auxiliary input means for the touch-based device (103) to supplement the touchscreen (113).

In one or more embodiments, the touch-based device (103) includes the biometric sensor (111) that is configured to obtain a biometric signal of a user. For example, the biometric sensor (111) may include one or more of a camera, a finger print scanner, a microphone, or other types of sensor capable of obtaining a signal representing biometric information of the user.

In one or more embodiments, the touch-based device (103) includes the biometric analyzer (121) that executes on the processor (114) and is configured to generate a biometric data item (not shown, referred to as a generated biometric data item) by analyzing the biometric signal obtained using the biometric sensor (111). In particular, the generated biometric data item (not shown) represents characteristics of a facial image, a finger print, a voice segment, or other types of biometric signal of the user that has been captured by the aforementioned camera, finger print scanner, microphone, or other types of biometric sensor, respectively. In one or more embodiments, the biometric data item includes intermediate information that is sampled, digitized, or otherwise extracted from the biometric signal. In one or more embodiments, the biometric data item includes processed information derived from the biometric signal. For example, such processed information may be in a pre-determined format and referred to as a biometric feature or a biometric signature (e.g., a facial image signature, a finger print signature, a voice signature, etc.) of the user from whom the biometric signal is captured. In one or more embodiments, the generated biometric data item contains only one type of biometric information relating to one of a facial image, a finger print, a voice segment, or other types of biometric signal of the user. In one or more embodiments, the generated biometric data item contains a composite of multiple types of biometric information relating to two or more of a facial image, a finger print, a voice segment, or other types of biometric signal of the user.

In one or more embodiments, the touch-based device (103) includes the user analyzer (122) that executes on the processor (114) and is configured to determine an identity of the user by comparing the generated biometric data item to a library of biometric data items (e.g., biometric data item A (125a), biometric data item B (125b), biometric data item N (125n), etc., referred to as stored biometric data items) stored in the touch-based device (103). For example, if the generated biometric data item of the user matches any of the stored biometric data item A (125a), biometric data item B (125b), or biometric data item N (125n), the user is identified as the user A (101a), user B (101b), or user N (101n), respectively. In one or more embodiments, each of the biometric data item A (125a), biometric data item B (125b), biometric data item N (125n), etc. is tagged with a user identifier representing the corresponding user (i.e., the user A (101a), user B (101b), user N (101n), etc.). Said in other words, each of the user A (101a), user B (101b), user N (101n), etc. is uniquely identified by a user identifier (not shown) that tags the corresponding stored biometric data item (i.e., the user A (101a), user B (101b), user N (101n), etc.). When the generated biometric data item of the user is matched to a particular stored biometric data item (e.g., biometric data item A (125a)), the user is identified as the corresponding user (i.e., user A (101a)) based on the user identifier tag assigned to the particular stored biometric data.

In one or more embodiments, any of generated biometric data item and the stored biometric data items (e.g., biometric data item A (125a)) may contain multiple types of biometric characteristics, such as relating to two or more of a facial image, finger print, voice segment, or other types of biometric characteristics. In such embodiments, the user analyzer (122) is configured to identify the user by matching at least one common biometric feature contained in both the generated biometric data item and one of the stored biometric data items (e.g., biometric data item A (125a)). In one or more embodiments, multiple biometric features are used in such matching to improve user identification accuracy of the user analyzer (122).

In one or more embodiments as noted above, any of the generated biometric data item and the stored biometric data items (e.g., biometric data item A (125a)) may contain intermediate information (e.g., digital facial image, digital finger print image, digital voice segment, etc.) from which user specific features may be extracted. For example, user specific features (e.g., facial image feature, finger print feature, voice feature, etc.) may be extracted from such intermediate information using techniques known to those skilled in the art. In such embodiments, the user analyzer (122) is configured to extract such feature from any generated and/or stored biometric data items containing intermediate information before completing the comparison to identify the user. In one or more embodiments, one or more of the generated biometric data item and the stored biometric data items (e.g., biometric data item A (125a)) may already contain such user specific features in a pre-determined format and is (are) ready for comparison without separate feature extraction step. In one or more embodiments, the generated biometric data item and the stored biometric data items may be mapped, either directly or after the aforementioned feature extraction, into a feature space (or hyperspace) for comparison based on distance measure between mapped data items in such feature space. Accordingly, the generated biometric data item may be identified as one of the stored biometric data items using feature space comparison techniques known to those skilled in the art.

In one or more embodiments, the touch-based device (103) includes the user data set selector (123) that executes on the processor (114) and is configured to activate a user data set stored on the single touch-based device (103) (i.e., user data set A (126a), user data set B (126b), user data set N (126n), etc.). Specifically, the activated user data set is activated in response solely to the aforementioned biometric signal and is activated based on the user identity (e.g., the user A (101a), user B (101b), user N (101n), etc.) identified from the biometric signal. In one or more embodiments, activating a user data set for different users may include different actions specific to the user depending on the contents and attributes of the activated user data set. In one or more embodiments, the specific action that is taken when activating the user data set may be defined in a profile included in the user data set. For example, the user data set A (126a) belongs to the user A (101a) and may include a user name and a password of the user A (101a). In this example, activating the user data set A (126a) may include using the user name and the password of the user A (101a) to automatically perform a login operation of the touch-based device (103) or a login operation of the software application (124) for the user A (101a). In another example, the user data set B (126b) belongs to the user B (101b) and may include a preference setting of the user B (101b). In this example, activating the user data set B (126b) may include using the preference setting of the user B (101b) to reconfigure the single touch-based device (103) or reconfigure the software application (124) for the user B (101b). In yet another example, the user data set N (126n) belongs to the user N (101n) and includes user specific application data to be used by the software application (124). In this example, activating the user data set N (126n) may include causing the software application (124) to perform a task for the user N (101n) using the user specific application data contained in the user data set N (126c). As noted above, the login operation, the reconfiguration, and the application task may be selectively performed according to an instruction stored in the user data set A (126a), user data set B (126b), user data set N (126c), respectively.

In one or more embodiments, the user data set selector (123) is further configured to deactivate a previously activated user data set (e.g., user data set A (126a)) on the single touch-based device (103) in response to determining that the previously activated user data set (e.g., user data set A (126a)) corresponds to a different user (e.g., user A (101a)) than the user (e.g., user B (101b)) who has taken over the possession of the single touch-based device (103).

In one or more embodiments, the user data set selector (123) is further configured to display a message on the single touch-based device (103) in response to determining that the generated biometric data item does not match any biometric data item in the library of biometric data items stored on the single touch-based device (103). For example, such message may invite a new user, who has taken over the possession of the single touch-based device (103), to register his biometric data item and user data set on the single touch-based device (103). In one or more embodiments, such new user registration may need to be performed by a system administrator. In another example, such message may instruct an unauthorized user, who has taken over the possession of the single touch-based device (103), to return the single touch-based device (103) to an authorized user. In this example, the user data set selector (123) may deactivate a portion of or the entire functionality of the single touch-based device (103) for security reasons.

In one or more embodiments, the touch-based device (103) includes the location-based sensor (112) that is configured to obtain a location-based data item (not shown) representing a location of the user in possession of the single touch-based device (103). In one or more embodiments, the functionalities of the biometric analyzer (121) and the user analyzer (122) may be adjusted according to the location. For example, the user A (101a) and user B (101b) may be employees authorized to be present in a restricted facility while the user N (101n) is a contractor un-authorized to be present in the restricted facility. Accordingly, when the location-based data item indicates the current location to be within the restricted facility, the user analyzer (122) may perform its function with improved speed or accuracy by limiting the comparison to a subset (126) of the stored biometric data items. For example, the subset (126) may contain only biometric data items of authorized persons to the restricted facilities. As shown for this example, the subset (126) contains the biometric data item A (125a) and biometric data item B (125b) of the authorized user A (101a) and authorized user B (101b), respectively.

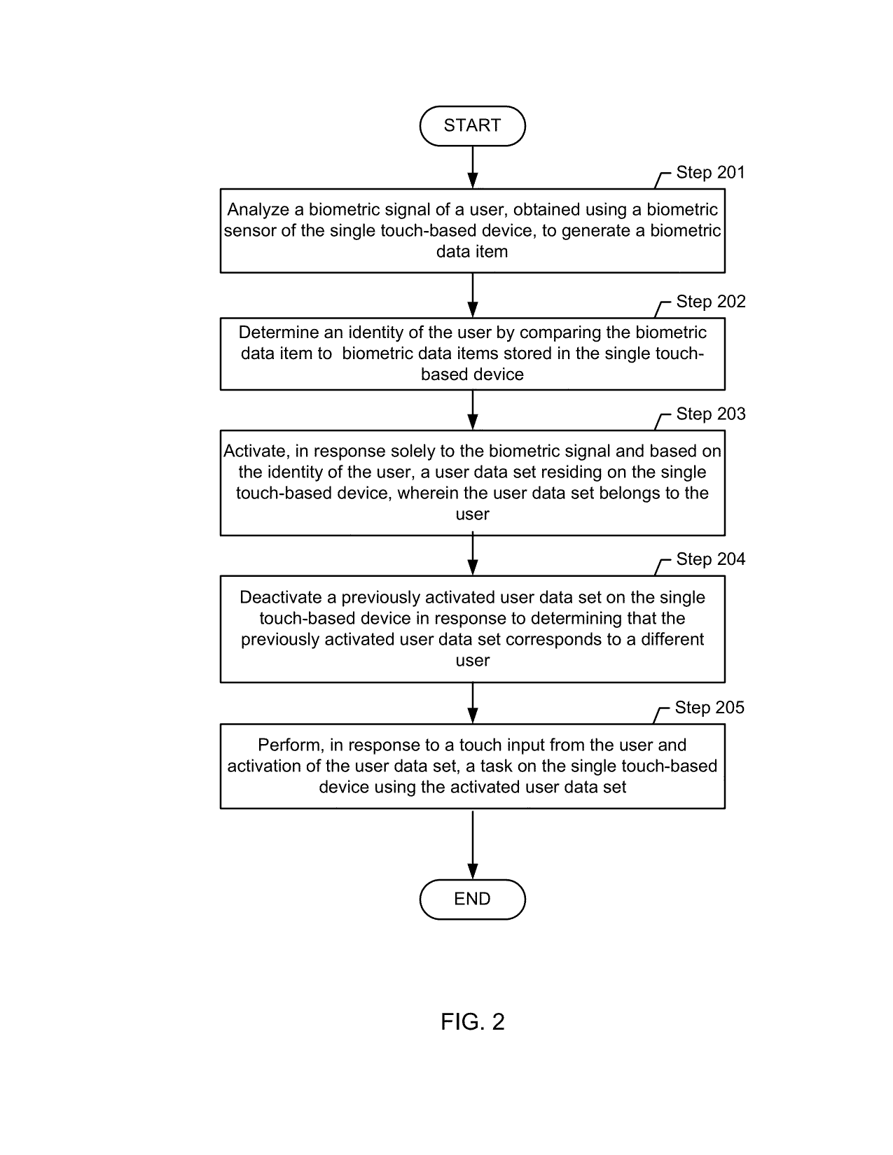

FIG. 2 depicts a flowchart of a method in accordance with one or more embodiments of the invention. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2. In one or more embodiments, the method described in reference to FIG. 2 may be practiced using the system (100) described in reference to FIG. 1 above.

As noted above, the method depicted in FIG. 2 provides a method for a single touch-based device to be automatically personalized when shared by multiple users.

Initially in Step 201, a biometric signal of a user obtained using a biometric sensor of the single touch-based device is analyzed to generate a biometric data item. In one or more embodiments, the biometric signal corresponds to a facial image, finger print, voice segment, or a composite thereof, of the user possessing the touch-based device. In particular, the biometric sensor may be a camera, a finger print sensor, a microphone, or a combination thereof integrated with the touch-based device. Accordingly, the biometric data item may include digital data extracted from such facial image, finger print, voice segment, or a composite thereof. In one or more embodiments, the biometric data item may be in an intermediate format form which user specific feature or signature in a pre-determined format may be extracted. In one or more embodiments, the biometric data item may already be processed into the user specific feature or signature in the pre-determined format. Whether in the intermediate format or as the fully processed feature/signature, the biometric data item generated in this manner may be referred to as the generated biometric data item.

In Step 202, an identity of the user is determined by comparing the generated biometric data item to biometric data items stored in the single touch based device. In one or more embodiments, previously obtained biometric data items representing biometric characteristics of registered users sharing the touch-based device are stored in a library on the touch-based device. For example, each stored biometric data item may contain a facial image, a finger print, a voice segment, and/or combinations thereof, of a corresponding one of the registered users. Accordingly, if the generated biometric data item of the user matches any of the stored biometric data items, the user is identified as one of the users previously registered to share the touch-based device. In one or more embodiments, each of the stored biometric data items is tagged with a user identifier representing the corresponding registered user. Said in other words, each of the registered users is uniquely identified by a user identifier that tags the corresponding stored biometric data item. When the generated biometric data item of the user in possession of the touch-based device is matched to a particular stored biometric data item, the user in possession of the touch-based device is identified as the corresponding registered user based on the user identifier tag assigned to the matched stored biometric data.

In one or more embodiments, any of the generated biometric data item and the stored biometric data items may contain multiple types of biometric characteristics, such as relating to two or more of a facial image, finger print, voice segment, or other types of biometric characteristics. In such embodiments, the user is identified by matching at least one common biometric feature contained in both the generated biometric data item and one of the stored biometric data items in the aforementioned library. In one or more embodiments, multiple biometric features are used in such matching to improve user identification accuracy.

In one or more embodiments as noted above, any of the generated biometric data item and the stored biometric data items may contain intermediate information (e.g., digital facial image, digital finger print image, digital voice segment, etc.) from which user specific features may be extracted. For example, user specific features (e.g., facial image feature, finger print feature, voice feature, etc.) may be extracted from such intermediate information using techniques known to those skilled in the art. In such embodiments, such feature may be extracted from any generated and/or stored biometric data items containing intermediate information before completing the comparison to identify the user. In one or more embodiments, one or more of the generated biometric data item and the stored biometric data items may already contain such user specific features in a pre-determined format and is (are) ready for comparison without a separate feature extraction step. In one or more embodiments, the generated biometric data item and the stored biometric data items may be mapped, either directly or after the aforementioned feature extraction, into a feature space (or hyperspace) for comparison based on distance measure between mapped data items in such feature space. Accordingly, the generated biometric data item may be identified as one of the stored biometric data items using feature space comparison techniques known to those skilled in the art.

In Step 203, in response solely to the biometric signal and based on the identity of the user derived from the biometric signal, a user data set residing on the single touch based device and belonging to the identified user is activated. In one or more embodiments, the biometric sensor continuously monitors the surroundings of the touch-based device to detect any user in possession of the touch-based device. If no user is detected, the touch-based device remains in a standby condition or a previously activated configuration (e.g., with a user data set remaining activated that belongs to a previous user in possession of the touch-based device). Once a live user is detected as in possession of the touch-based device (e.g., in response to detecting a valid facial image, finger print, or voice segment based on a pre-determined criterion), the user may be identified as one of the registered users allowed to share the touch-based device, or otherwise classified as a new user or an unauthorized user.

In Step 204, a previously activated user data set on the single touch-based device is deactivated in response to determining that the previously activated user data set corresponds to a different user than the user in possession of the touch-based device. For example, the previous user may have intentionally turned over the touch-based device to the user currently in possession. In another example, the touch-based device may have been picked up by the user currently in possession un-intentionally. In either case, the user data set belonging to the user previously in possession of the touch-based device is immediately deactivated upon determining someone else is now in possession of the touch-based device.

In Step 205, in response to the activation of the user data set, a task is performed on the touch-based device using the activated user data set. For example, the activated user data set may include a user name and a password of the user in possession of the touch-based device. In this example, in response to the user data set activation, a login operation of the touch-based device or a software application installed thereon may be automatically performed using the user name and the password.

In another example, the activated user data set may include a preference setting of the user in possession of the touch-based device. In this example, in response to the user data set activation, the single touch-based device or a software application installed thereon may be automatically reconfigured using the activated preference setting.

In yet another example, the activated user data set may include user specific application data of the user in possession of the touch-based device. In this example, in response to the user data set activation, a software application installed on the single touch-based device may automatically perform a task using the activated user specific application data.

In one or more embodiments, the aforementioned login operation, the reconfiguring action, and/or the software application task may be automatically performed further in response to an input from a user in possession of the touch-based device. Specifically, such input is simplified because any user specific information (e.g., user name, password, preference setting, application data) is automatically provided. Accordingly, the required user input to perform the login operation, reconfiguration action, and performing the application task may be limited to a single key (one a physical keyboard or a virtual keyboard) operation or a simple voice activated command.

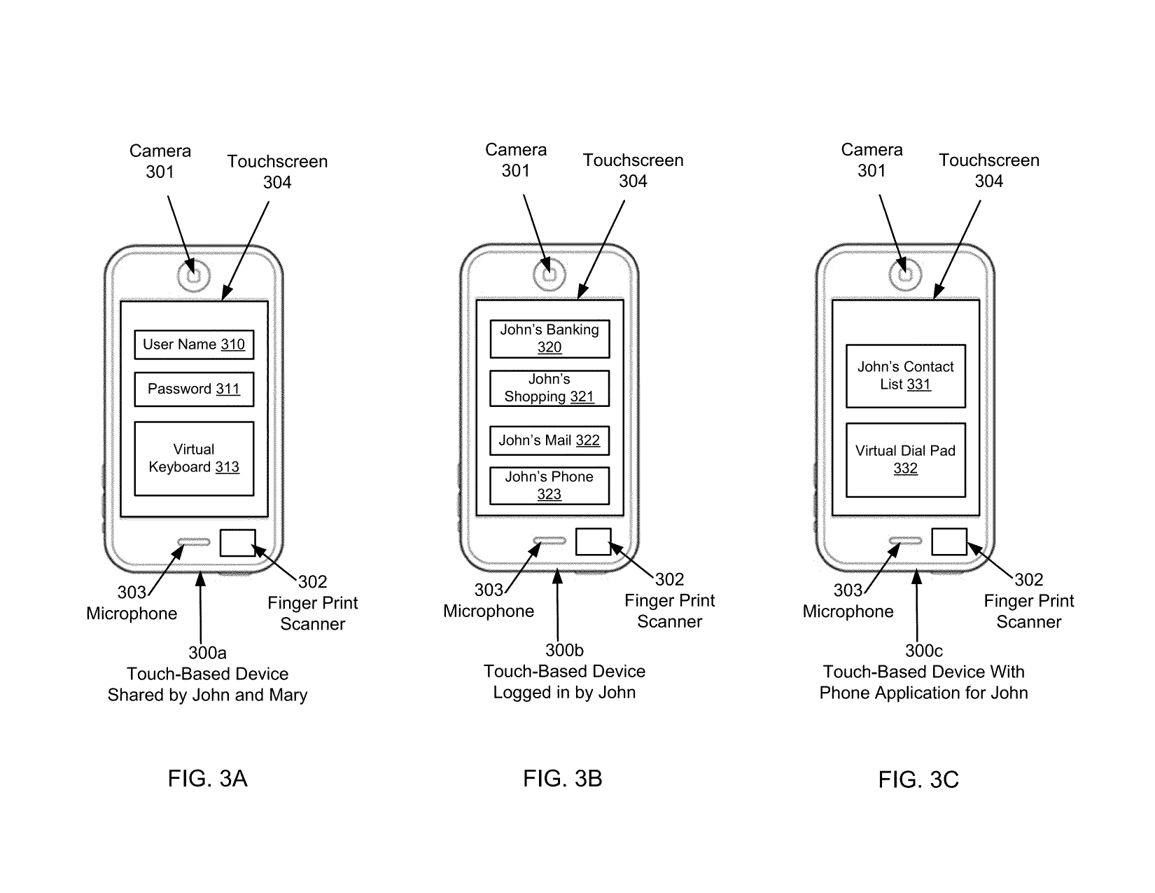

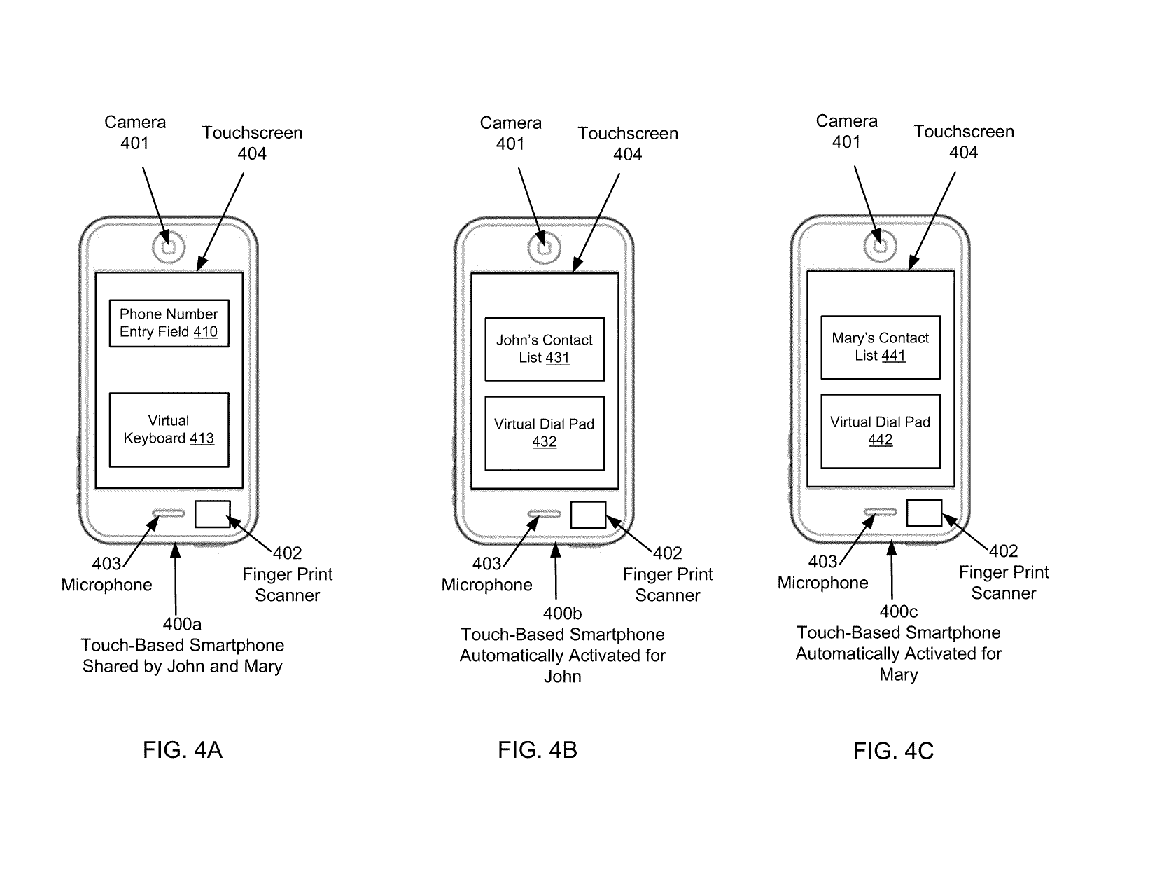

FIGS. 3A-3C and 4A-4C show an application example in accordance with one or more embodiments of the invention. This example application may be practiced using the system (100) of FIG. 1 and based on the method described with respect to FIG. 2 above.

The example depicted in FIGS. 3A-3C and 4A-4C is based on a touch-based device of the present invention that is (i) shared by two registered user John and Mary, (ii) installed with an automatic data set activator, and (iii) loaded with Johns' data set and Mary's data set. As noted above, the biggest pain-point in the multi-user sharing process is the manual and time-consuming keying-in of user specific data to personalize the touch-based device. The example depicted in FIGS. 3A-3C and 4A-4C solves this problem by entirely eliminating the manual data entry. As shown, the scenario may be applicable to target audience such as (i) small and medium sized business where a mobile device can be shared amongst employees (e.g., John and Mary), (ii) a household where a device can be shared by family members (e.g., John and Mary), or (iii) any other scenario where multiple users (e.g., John and Mary) need to share the same device.

In the example, the illustrated solution is to enable easy login and registration for multiple users on a single touch-based device. The solution eliminates manual data entry during switching of user data sets by automatically capturing and validating user identity. Example mechanisms to validate identity of the user are face recognition, fingerprint recognition, voice recognition, location-based login (e.g., a user can access a mobile device only on his desk or other pre-determined location(s)), near field communication (NFC) based identity tag, or a combination of any of the above methods.

FIG. 3A shows a touch-based device (300a) shared by John and Mary. This touch-based device (300a) includes a camera (301), finger print scanner (302), microphone (303), and touchscreen (304). As shown, when the touch-based device (300a) is not in possession by either John or Mary, the touchscreen (304) displays data entry fields of user name (310) and password (311), as well as a virtual keyboard (313). Accordingly, any user may login to the touch-based device (300a) by manually entering a valid user name and password into the data entry fields of user name (310) and password (311) using the virtual keyboard (313).

FIG. 3B shows a touch-based device (300b) that is essentially the touch-based device (300a), but this time it is in possession by John. This touch-based device (300b) includes the same camera (301), finger print scanner (302), microphone (303), and touchscreen (304) shown in FIG. 3A. In this example, John's data set stored in the touch-based device (300b) contains an instruction to display, upon login, a multi-function application menu with personalized settings. As shown, when the touch-based device (300b) is picked up by John, the camera (301) captures a facial image of John that is recognized by the automatic data set activator such that the touchscreen (304) displays the application menu including various touch fields such as John's banking (320), John's shopping (321), John's mail (322), and John's phone (323). Accordingly, when John touches the touch field John's banking (320), the touch-based device (300b) will automatically access a bank website using URL stored in John's data set and is pre-configured to access John's bank account. When John touches the touch field John's shopping (321), the touch-based device (300b) will automatically access a shopping website using URL stored in John's data set and is pre-configured to access John's favorite shopping website. When John touches the touch field John's mail (322), the touch-based device (300b) will automatically access emails using an email account information stored in John's data set and is pre-configured to access John's email account. When John touches the touch field John's phone (323), the touch-based device (300b) will automatically display mobile phone user interface using a contact list stored in John's data set and is pre-configured to list John's phone contacts.

FIG. 3C shows a touch-based device (300c) that is essentially the touch-based device (300b), but this time it is in possession by John after John touches the touch field John's phone (323). This touch-based device (300c) includes the same camera (301), finger print scanner (302), microphone (303), and touchscreen (304) shown in FIGS. 3A and 3B. In this example, John's data set stored in the touch-based device (300c) contains John's phone contacts. As shown, when John picks up the touch-based device (300b) and touches the touch field John's phone (323), the touchscreen (304) displays John's personalized mobile phone menu showing John's contact list (331) and a virtual dial pad (332). Accordingly, John can conveniently initiate a phone call using John's contact list (331).

FIG. 4A shows a touch-based smartphone (400a) shared by John and Mary. This touch-based smartphone (400a) includes a camera (401), finger print scanner (402), microphone (403), and touchscreen (404). As shown, when the touch-based smartphone (400a) is not in possession by either John or Mary, the touchscreen (404) displays a phone number entry field (410) and a virtual keyboard (413). Accordingly, any user may use the touch-based smartphone (400a) to initiate a call by manually entering a phone number into the phone number entry (410) using the virtual keyboard (413).

FIG. 4B shows a touch-based smartphone (400b) that is essentially the touch-based smartphone (400a), but this time it is in possession by John. This touch-based smartphone (400b) includes the same camera (401), finger print scanner (402), microphone (403), and touchscreen (404) shown in FIG. 4A. In this example, John's data set stored in the touch-based device (400b) contains John's phone contacts. As shown, when John picks up the touch-based smartphone (400b), the camera (401) captures a facial image of John that is recognized by the automatic data set activator such that the touchscreen (404) displays John's personalized smartphone menu showing John's contact list (431) and a virtual dial pad (432) of John's style of choice. Accordingly, John can conveniently initiate a phone call using John's contact list (431).

FIG. 4C shows a touch-based smartphone (400c) that is essentially the touch-based smartphone (400b), but this time it is given to Mary after John finishes using the touch-based smartphone (400b). This touch-based smartphone (400c) includes the same camera (401), finger print scanner (402), microphone (403), and touchscreen (404) shown in FIGS. 4A and 4B. In this example, Mary's data set stored in the touch-based device (400c) (or the touch-based device (400a) and the touch-based device (400b)) contains Mary's phone contacts. As shown, when Mary picks up the touch-based smartphone (400c) from John, the camera (401) captures a facial image of Mary that is recognized by the automatic data set activator such that the touchscreen (404) turns off John's personalized smartphone menu showing John's contact list (431) and the virtual dial pad (432). Further, the touchscreen (404) now displays Mary's personalized smartphone menu showing Mary's contact list (441) and a virtual dial pad (442) of Mary's style of choice. Accordingly, Mary can conveniently initiate a phone call using Mary's contact list (441). As an example, John and Mary may be outbound sales agents for a small business where John uses the shared touch-based smartphone when he works outside of the office in the morning and Mary uses the same shared touch-based smartphone when she works outside of the office in the afternoon. In particular, John turns in the shared touch-based smartphone when he returns to work in the office for the afternoon while Mary checks out the shared touch-based smartphone after she completes her morning tasks in the office and gets ready for her afternoon tasks outside of the office. Based on the automatic switching of user data described above, John's sales calls are logged in a personalized call log separate from Mary's personalized call log that logs her sales calls. Accordingly, sales credit for closing each customer transaction can be tracked based on the separate sales call logs.

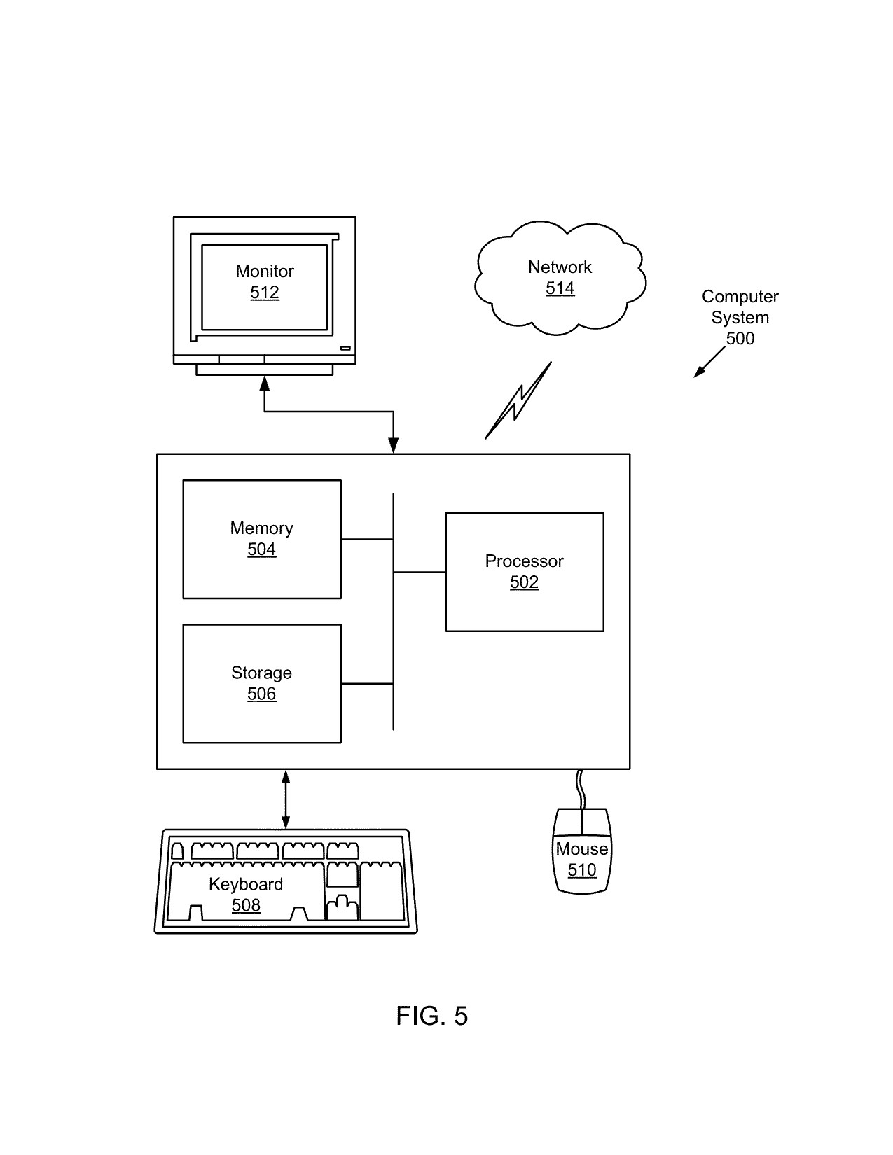

Embodiments of the invention may be implemented on virtually any type of computer regardless of the platform being used. For example, as shown in FIG. 5, a computer system (500) includes one or more processor(s) (502) such as a central processing unit (CPU), integrated circuit, or other hardware processor, associated memory (504) (e.g., random access memory (RAM), cache memory, flash memory, etc.), a storage device (506) (e.g., a hard disk, an optical drive such as a compact disk drive or digital video disk (DVD) drive, a flash memory stick, etc.), and numerous other elements and functionalities typical of today's computers (not shown). The computer system (500) may also include input means, such as a keyboard (508), a mouse (510), or a microphone (not shown). Further, the computer system (500) may include output means, such as a monitor ((512) (e.g., a liquid crystal display (LCD), a plasma display, or cathode ray tube (CRT) monitor). The computer system (500) may be connected to a network (514) (e.g., a local area network (LAN), a wide area network (WAN) such as the Internet, or any other similar type of network)) with wired and/or wireless segments via a network interface connection (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

Further, those skilled in the art will appreciate that one or more elements of the aforementioned computer system (500) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to use a single touch-based device for a plurality of users, comprising:
analyzing a biometric signal of a user, obtained using a biometric sensor of the single touch-based device, to generate a biometric data item;
determining an identity of the user by comparing the biometric data item to a plurality of biometric data items stored in the single touch-based device;
activating, in response solely to the biometric signal and based on the identity of the user, a user data set residing on the single touch-based device, wherein the user data set belongs to the user; and
performing, in response to a touch input from the user and activation of the user data set, a task on the single touch-based device using the user data set.

2. The method of claim 1,
wherein the biometric sensor comprises at least one selected from a group consisting of a camera, a finger print scanner, and a microphone,
wherein the biometric data item represents characteristics of at least one selected from a group consisting of a facial image, a finger print, and a voice segment of the user.

3. The method of claim 1, further comprising:
selecting, based on the identity, the user data set from a plurality of user data sets stored on the single touch-based device.

4. The method of claim 1, further comprising:
deactivating a previously activated user data set on the single touch-based device in response to determining that the previously activated user data set corresponds to a different user than the user.

5. The method of claim 1,
wherein the user data set comprises a user name and a password of the user, and
wherein activating the user data set comprises performing a login operation using the user name and the password.

6. The method of claim 1,
wherein the user data set comprises a preference setting of the user, and
wherein activating the user data set comprises reconfiguring the single touch-based device using the preference setting.

7. The method of claim 1, further comprising:
obtaining, using a location-based sensor of the single touch-based device, a location-based data item representing a location of the user carrying the single touch-based device; and
retrieving a subset of the plurality of biometric data items based on the location-based data item,
wherein identifying the user is by comparing the biometric data item to the subset.

8. A single touch-based device for a plurality of users, comprising:
a processor;
a touchscreen configured to receive a touch input from a user;
a biometric sensor configured to obtain a biometric signal of the user;
a biometric analyzer executing on the processor and configured to generate a biometric data item by analyzing the biometric signal;
a user analyzer executing on the processor and configured to determine an identity of the user by comparing the biometric data item to a plurality of biometric data items;
a user data set selector executing on the processor and configured to activate, in response solely to the biometric signal and based on the identity, a user data set residing on the single touch-based device and belonging to the user;
a software application executing on the processor and configured to perform, in response to the touch input and activation of the user data set, a task on the single touch-based device using the user data set; and
a repository configured to store the plurality of biometric data items and a plurality of user data sets comprising the user data set.

9. The single touch-based device of claim 8,
wherein the biometric sensor comprises at least one selected from a group consisting of a camera, a finger print scanner, and a microphone,
wherein the biometric data item represents characteristics of at least one selected from a group consisting of a facial image, a finger print, and a voice segment of the user.

10. The single touch-based device of claim 8,
wherein the repository is further configured to store from a plurality of user data sets corresponding to the plurality of users, and
wherein the user data set selector is further configured to select the user data set from the plurality of user data sets based on the identity.

11. The single touch-based device of claim 8,
wherein the user data set selector is further configured to deactivate a previously activated user data set on the single touch-based device in response to determining that the previously activated user data set corresponds to a different user than the user.

12. The single touch-based device of claim 8,
wherein the user data set comprises a user name and a password of the user, and
wherein activating the user data set comprises performing a login operation using the user name and the password.

13. The single touch-based device of claim 8,
wherein the user data set comprises a preference setting of the user, and
wherein activating the user data set comprises reconfiguring the single touch-based device using the preference setting.

14. The single touch-based device of claim 8, further comprising:
a location-based sensor configured to obtain a location-based data item representing a location of the user carrying the single touch-based device,
wherein the user analyzer is further configured to retrieve a subset of the plurality of biometric data items based on the location-based data item, and
wherein identifying the user is by comparing the biometric data item to the subset.

15. A non-transitory computer readable medium storing instructions to control a single touch-based device for a plurality of users, the instructions when executed by a computer processor comprising functionality to:
analyze a biometric signal of a user, obtained using a biometric sensor of the single touch-based device, to generate a biometric data item;
determine an identity of the user by comparing the biometric data item to a plurality of biometric data items stored in the single touch-based device;
activate, in response solely to the biometric signal and based on the identity of the user, a user data set residing on the single touch-based device, wherein the user data set belongs to the user; and
perform, in response to a touch input from the user and activation of the user data set, a task on the single touch-based device using the user data set.

16. The non-transitory computer readable medium of claim 15,
wherein the biometric sensor comprises at least one selected from a group consisting of a camera, a finger print scanner, and a microphone,
wherein the biometric data item represents characteristics of at least one selected from a group consisting of a facial image, a finger print, and a voice segment of the user.

17. The non-transitory computer readable medium of claim 15, the instructions when executed by the computer processor further comprising functionality to:
select, based on the identity, the user data set from a plurality of user data sets stored on the single touch-based device.

18. The non-transitory computer readable medium of claim 15, the instructions when executed by the computer processor further comprising functionality to:
deactivate a previously activated user data set on the single touch-based device in response to determining that the previously activated user data set corresponds to a different user than the user.

19. The non-transitory computer readable medium of claim 15,
wherein the user data set comprises a user name and a password of the user, and
wherein activating the user data set comprises performing a login operation using the user name and the password.

20. The non-transitory computer readable medium of claim 15,
wherein the user data set comprises a preference setting of the user, and
wherein activating the user data set comprises reconfiguring the single touch-based device using the preference setting.

21. The non-transitory computer readable medium of claim 15, the instructions when executed by the computer processor further comprising functionality to:
obtain, using a location-based sensor of the single touch-based device, a location-based data item representing a location of the user carrying the single touch-based device; and
retrieve a subset of the plurality of biometric data items based on the location-based data item,
wherein identifying the user is by comparing the biometric data item to the subset.
